(19) United States
(12) Patent Application Publication
(10) Pub. No.: US 2023/0158875 A1
(43) Pub. Date: May 25, 2023

(54) VEHICLE HAIL PROTECTION SYSTEM AND ASSOCIATED HAIL PROTECTION TARPAULIN

(71) Applicant: Cédric MIGNONAT, Toulouse (FR)

(72) Inventor: Cédric MIGNONAT, Toulouse (FR)

(21) Appl. No.: 17/912,500

(22) PCT Filed: Mar. 17, 2021
(86) PCT No.: PCT/EP2021/056772

§ 371 Date: Sep. 17, 2022

(30) Foreign Application Priority Data
Mar. 17, 2020 (FR) FR2002586

(51) Int. Cl. B60J 11/04; B60J 11/02; B32B 27/08

(52) U.S. Cl. CPC B60J 11/04; B32B 27/08; B60J 11/02; B32B 2307/56; B32B 2307/5825; B32B 2307/7265; B32B 2571/00

(57) ABSTRACT

The invention relates to a hail protection tarpaulin (2) for a vehicle (100). The tarpaulin comprises at least one ductile intermediate layer (22) with a low shrinkage rate, made up of at least one type of vibroabsorbent elastomer arranged in crystalline viscoelastic microcells, capable of absorbing and horizontally dispersing the shocks produced by the impact of the hail on the hail protection tarpaulin (2). The invention also relates to a storage mechanism (4) for a hail protection tarpaulin (2) as well as a hail protection system.

### DESCRIPTION

The present invention relates to a hail protection tarpaulin, a mechanism for storing the hail protection tarpaulin, and a hail protection system for a vehicle and an associated hail protection tarpaulin. It is applicable in general to the protection of the bodies of motor vehicles from hailstorms.

Hailstorms are responsible for extensive damage to vehicles each year, including scratches and dents on the body of vehicles, as well as impact damage, cracks, and glass breakage on certain parts of the vehicle.

By vehicles, we mean any vehicle comprising bodywork to be protected, and having an underbody suitable for the hail protection system according to the invention.

We already have neoprene or EVA protective tarpaulins, which are light but susceptible to wear and tear, and do not have sufficient energy dispersion properties to withstand the shock of hail against the vehicle.

On the one hand, the installation of these hail protection tarpaulins on the vehicle is often complicated, and does not guarantee the user an adaptability to any type of vehicle to provide optimal protection while allowing easy implementation and storage.

On the other hand, current hail protection systems can be integrated into the vehicle and have means of deployment and storage of said tarpaulin, but their position in the trunk of the vehicle, or integrated into the bumper of the same, complicates the handling of the systems, and makes said systems vulnerable in the event of a vehicle collision.

These systems are not configured to accommodate protective tarpaulins that are strong enough to effectively protect vehicles from hailstorms without a large space requirement.

This invention remedies these drawbacks.

It concerns a hail protection tarpaulin for a vehicle.

According to a general definition of the invention, the hail protection tarpaulin comprises at least one ductile intermediate layer with a low shrinkage rate, made up of at least one type of vibroabsorbent elastomer arranged in crystalline viscoelastic microcells, capable of absorbing and horizontally dispersing the shocks produced by the impact of hail on said hail protection tarpaulin.

According to one embodiment of the invention, the protective tarpaulin comprises a multilayer structure describing:
an outer water-resistant and tear-resistant layer intended to be in contact with the hail;
a non-abrasive inner layer intended to be put in direct contact with the vehicle to be protected; and
the intermediate layer being arranged between the outer layer and the inner layer.

In practice, the intermediate layer of the hail protection tarpaulin is composed of a material sold under the trademark NOENE^{®} by the DIAFARM LABORATORIOS company.

Advantageously, the hail protection tarpaulin according to the invention allows for effective protection of the vehicle from hailstorms, by effectively dispersing the kinetic energy transferred by the impact of the hail to the protective tarpaulin according to the invention.

According to an embodiment of the invention, the hail protection tarpaulin comprises a central panel adapted to cover the vehicle lengthwise in a central position, and side flaps adapted to be unfolded and to cover the vehicle fenders.

In practice, the hail protection tarpaulin comprises at least two lines of attenuation arranged in the direction of the length of said protection tarpaulin, and make it possible to fold the side flaps of the protection tarpaulin towards the central panel of the latter, and to unfold the side flaps of the hail protection tarpaulin from the central panel towards the vehicle fenders.

By way of example, the hail protection tarpaulin comprises fastening means disposed on a distal end of said hail protection tarpaulin, adapted to fasten to the front part of the vehicle and allow the hail protection tarpaulin to be held in the deployed position.

According to a particular embodiment in accordance with the invention, the hail protection tarpaulin comprises a fastening means allowing the tarpaulin to be locked in a folded position according to a chosen width, and allowing the said hail protection tarpaulin to be stored.

The invention also relates to a storage mechanism applied to a hail protection tarpaulin.

According to another aspect of the invention, the storage mechanism applied to a hail protection tarpaulin comprises storage means that can be fixed to the rear chassis of the vehicle, and comprises:
storage means for said tarpaulin, that can be fixed to a part of the vehicle
two rotating rollers parallel to each other and to the axles of the vehicle, arranged at a chosen distance from each other, and able to roll up the hail protection tarpaulin onto itself, under tension between the two rollers according to a rolling up configuration whose rolling up center corresponds to the two rotating rollers in order to allow for a lengthwise storage of the tarpaulin;
a drive loop surrounding the two rotating rollers, attached to the proximate end of the hail protection cover in order to provide an anchoring point during the storage procedure of said protection tarpaulin; and
a driving means arranged on at least one of the rotating rollers, adapted to rotate said rotating roller and thus cause the storage of the hail protection tarpaulin in the storage means, and adapted to allow the passage from a deployed state, in which the hail protection tarpaulin at least partially covers the vehicle, to a retracted state of the hail protection tarpaulin in which the hail protection tarpaulin is housed and rolled up according to a configuration selected from the storage means.

For example, the driving means belongs to the group formed by a step motor, a spring-type elastic return means.

In practice, the hail protection system according to the invention comprises a disengaged mode in which the rotating rollers are disengaged from the driving means allowing the manual deployment of the protection tarpaulin.

The invention also relates to a hail protection system.

According to another aspect of the invention, the hail protection system comprises a protection tarpaulin in accordance with the invention, and a storage mechanism in accordance with the invention.

Astutely, the invention allows the user to benefit from a deployment and storage system that is easy to operate, that is mechanically assisted, and that is adapted to a more robust hail protection tarpaulin than that of the prior art.

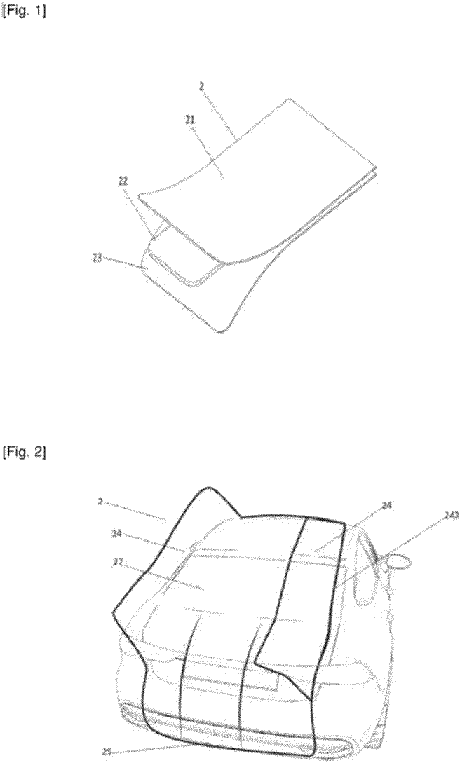

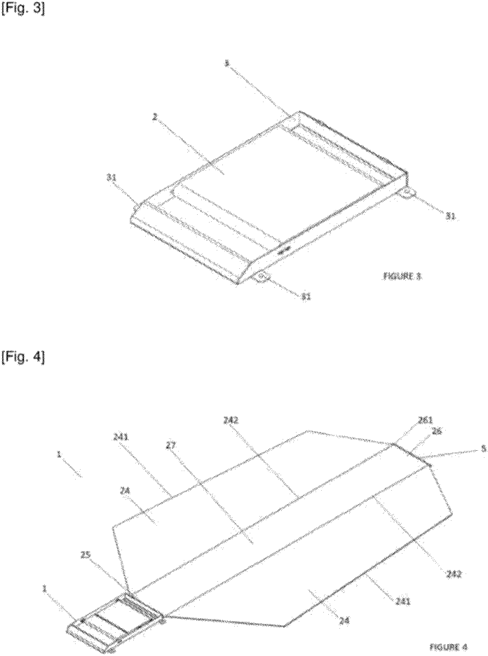

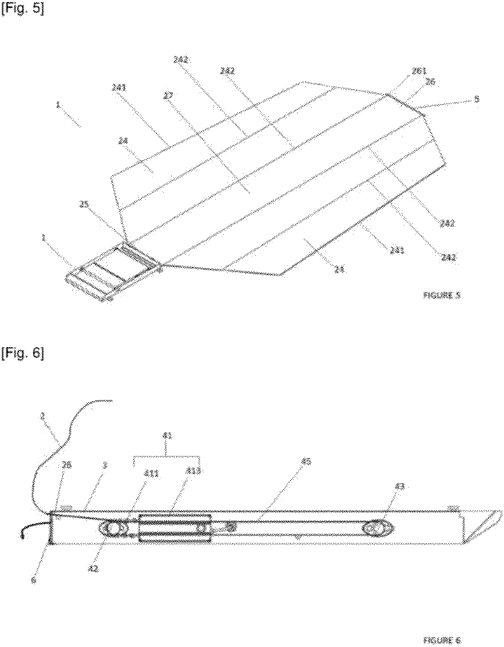

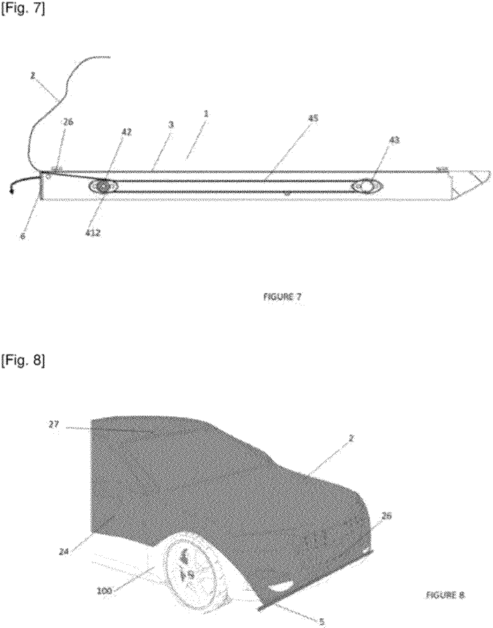

Further advantages and features of the invention will become apparent from the description and drawings in which:

[FIG. 1] schematically depicts the hail protection tarpaulin according to the invention;

[FIG. 2] schematically depicts the hail-protection tarpaulin in a deployed state on a vehicle according to the invention;

[FIG. 3] schematically depicts the storage means of the hail protection system according to the invention;

[FIG. 4] schematically depicts a first embodiment of the hail protection system according to the invention;

[FIG. 5] schematically depicts a second embodiment of the hail protection system according to the invention;

[FIG. 6] schematically depicts a first embodiment of the storage means of the hail protection system according to the invention;

[FIG. 7] schematically depicts a second embodiment of the storage means of the hail protection system according to the invention; and

[FIG. 8] schematically depicts a front view of the hail protection tarpaulin deployed on a vehicle according to the invention.

With reference to FIGS. 1 to 8, the hail protection system 1 for a vehicle 100 according to the invention comprises a hail protection tarpaulin 2, as well as storage means 3 of said hail protection tarpaulin 2, adapted to be attached to a vehicle 100, and a storage mechanism 4, adapted to allow the mechanically assisted storing of the protection tarpaulin 2 in said storage means 3.

The hail protection system 1 comprises a hail protection tarpaulin 2, hereinafter referred to as a protection tarpaulin 2, which can be deployed on a vehicle 100 in order to protect it from hail damage, the structure of which has at least one protective layer with select properties, hereinafter referred to as an intermediate layer 22.

The intermediate layer 22 is comprised of a particular viscoelastic rubber with vibroabsorbent properties. The elastomers composing this particular rubber are composed of crystalline microcells arranged in such a way as to allow the absorption and dispersion on a horizontal plane of the kinetic energy transmitted to the protective tarpaulin 2 during an impact.

In practice, the intermediate layer 22 of the protection tarpaulin 2 is composed of a material sold under the trademark NOENE^{®} by the company DIAFARM LABORATORIOS or similar viscoelastic material with the same vibroabsorbing properties.

Surprisingly, the Applicant has observed that the NOENE^{®} material, normally used in the paramedical industry for the manufacture of shoe soles, allows an optimization of the shock absorption characteristics, and allows for better protection of the vehicle to be protected.

In addition, the crystalline microcell structure allows the material to provide the tarpaulin 2 with excellent impact resistance, while allowing it to remain flexible, and thus to deform without breaking.

Finally, the said structure of the intermediate layer 22 has a low shrinkage rate, and thus allows it to maintain its shape as well as its vibroelastic properties despite the impacts absorbed during prolonged use.

According to a particular embodiment in accordance with the invention, the intermediate layer 22 is composed of 100% of the viscoelastic elastomer having vibroabsorbent properties comprising a structure arranged in crystalline microcells.

According to a particular embodiment of the invention, the protection tarpaulin 2 comprises a multi-layer structure describing 3 layers superimposed on each other, forming a multi-layer assembly with high impact resistance, and able to absorb and then horizontally disperse the impact of the hail, the multi-layer assembly being present at any point of said protection tarpaulin 2 thus providing the same degree of protection at any point of the tarpaulin 2 covering the areas of the vehicle to be protected.

Such a structure also allows an efficient absorption of the kinetic energy of various objects including hail, but also to limit the damage which can occur during falls of medium-sized trees and branches.

The protection tarpaulin 2 comprises a first layer called external layer 21, waterproof and comprised of a tear-resistant material, able to receive hail impacts while protecting the lower layers from wear.

As a non-exhaustive example, the outer layer 21 is made of treated nylon.

The protection tarpaulin 2 comprises a second layer, the so-called inner layer 23, made of a selected non-abrasive material, configured to be in direct contact with the surface of the vehicle 100 to be protected, capable of protecting the underlying elements of the vehicle 100 from marks and scratches caused by the friction of said inner layer 23 with the vehicle 100.

As a non-exhaustive example, the inner layer 23 is made of soft non-abrasive nylon.

The protection tarpaulin 2 comprises then the intermediate layer 22, placed between the external layer 21 and the internal layer 23.

The hail protection tarpaulin 2 has a deployed state, in which it at least partially covers the vehicle 100, as well as a retracted state, in which the tarpaulin is rolled up in a particular roll-up configuration in the storage means 3 of system 1.

The tarpaulin 2 has a central panel 27, which is able to cover the horizontal or quasi-horizontal surfaces along the entire length of the vehicle 100, as well as the rear and front vertical parts of the vehicle 100.

The central panel 27 of the protection tarpaulin 2 comprises a proximal part 25 adapted to be attached by at least one driving loop 45 to the storage mechanism 4 arranged in the storage means 3, and a distal part 26 configured to cover at least partially the front vertical part of the vehicle 100.

According to an embodiment of the invention, the distal portion 26 of the protective cover 2 comprises means for securing in the deployed position 5, arranged on the edge 261 of the distal portion 26 of the protection tarpaulin 2.

The protection tarpaulin 2 further comprises at least two side flaps 24, which can be unfolded during the deployment of the tarpaulin 2, and thus cover the vertical or quasi-vertical side surfaces of the vehicle 100, hereinafter referred to as the fenders of the vehicle 100.

According to another embodiment, the two side flaps 24 of the protection tarpaulin 2 comprise means for securing in the deployed position 5 arranged on their ends 241.

Alternatively, the protection tarpaulin 2 of the hail protection system 1 according to the invention comprises means of attachment in the deployed position 5 on the two side flaps 24 and on the distal part 26 of the tarpaulin 2, the tarpaulin 2 being attached at the level of the chassis on the front of the vehicle 100, thus avoiding any attachment to the body of the vehicle 100.

The means of holding in a deployed position 5 belong non exhaustively to the group formed by ballast, magnetized surfaces, hook, elastic.

According to an embodiment in accordance with the invention, the protection tarpaulin 2 comprises at least two lines of attenuation 242, arranged along the length of said tarpaulin 2, and adapted to allow the folding of the side panels 24 of the protection tarpaulin 2 towards the central panel 27 according to a chosen final width adapted to the storage means 3.

The lines of attenuation 242 incidentally allow the unfolding of said side panels 24 on the sides of the vehicle 100 during the deployment of the protection tarpaulin 2.

Additional lines of attenuation 242 may be added to adjust the tarpaulin 2 to accommodate different shapes of vehicles 100. These additional lines of attenuation 242 may be arranged parallel or perpendicular to the axles of the vehicle 100 on the tarpaulin 2.

Once the side flaps 24 are folded on the central panel 27, the protection tarpaulin 2 can be retracted into the storage means 3 by the storage mechanism 4.

In practice, the protection tarpaulin 2 also comprises means (not shown) for holding the side flaps 24 in a folded position, and able to maintain the protection tarpaulin 2 in a folded configuration during the storage procedure.

As a non-exhaustive example, the means of holding the side flaps 24 in a folded position belong to the group formed by a velcro surface, magnetic strap.

With reference to FIGS. 3 to 7, the hail protection system 1 further comprises storage means 3 forming a storage compartment mechanism, and adapted to be fixed to the rear part of the underbody of the vehicle 100 by selected fastening means 31.

The storage means 3 of the protection tarpaulin 2 comprise a substantially parallel-pipedic case, as well as a trapdoor-type opening 6, which can be opened manually in order to allow access to the distal part 26 of the protection tarpaulin 2 by the user in order to initiate the deployment of the latter, and to lock the access to the protection tarpaulin 2 once the latter has been retracted into the storage means 3.

Such a system does not require any change to the design of the vehicle 100, because of its positioning on the rear chassis.

In practice, the upper part of the storage means 3, in contact with the rear underbody of the vehicle 100, comprises a thermally insulating surface, capable of protecting the protection tarpaulin 2 from the exhaust system of the vehicle 100.

Advantageously, the arrangement of the storage means 3 under the vehicle, permanently fixed under the chassis, at the rear part of the underbody of the said vehicle 100 also makes it possible to prevent any theft attempt, as access to it is made more difficult.

Moreover, the arrangement of the storage means 3 under the chassis, at the level of the rear part of the underbody of the vehicle 100, means that it is protected against shocks during parking maneuvers.

Astutely, the arrangement of the storage means 3 under the chassis makes it possible to store the hail protection tarpaulin 2 without it causing any obstruction in the trunk of said vehicle 100, and prevents the introduction of particles and dirt into said trunk.

The storage means 3 includes a storage mechanism 4 for the protective cover 2, which allows the protective cover 2 to be stored from a folded and deployed state to a retracted state in the storage means 3.

The storage mechanism 4 of the hail protection system 1 according to the invention comprises two rotatable rollers 42, 43, which are parallel to each other and to the axles of the vehicle 100, and are arranged at a selected distance from each other.

The storage mechanism 4 further comprises a drive loop 45, surrounding the rotating rollers 42, 43, stretched between said rotating rollers 42, 43, integrated with the proximal portion 25 of the protection tarpaulin 2 in order to provide an anchoring point allowing the storage of the protection tarpaulin 2 in the form of a rolling of the tarpaulin on itself.

The driving loop 45 acts as a strap and a guide for the rolling up of the protection tarpaulin 2.

The two rotating rollers 42, 43 as well as the driving loop 45 are thus able to roll up the protection tarpaulin 2, while maintaining said tarpaulin 2 under tension between the two rollers 42, 43, in order to allow for storage lengthwise of the latter according to a configuration of rolling up on itself, whose center of rolling up corresponds to the two rotating rollers 42, 43.

According to one embodiment of the invention, at least one rotating roller 42 is connected to driving means 41 in order to allow the storage of the protection tarpaulin 2 according to the chosen roll-up configuration.

In practice, the driving means 41 belong to the group formed by elastic return means of the spring type 412, step motor 413.

The storage mechanism 4 further comprises a transmission means 411 connecting at least one rotating roller 42, 43, to the motorized driving means 413, and is adapted to drive the rotating roller 42 in order to allow for the storage of the protection tarpaulin 2 in the storage means 3.

In practice, the motorized driving means 41 comprises a power source capable of driving the step motor 413.

According to a particular embodiment of the invention, the driving means 41 of the storage mechanism 4 are disengageable, thus allowing the hail protection system 1 to have a disengaged mode, allowing deployment from a retracted state, to a deployed state of the protection tarpaulin 2.

According to a particular embodiment of the invention, the hail protection system 1 comprises a manual activation means of the push button type (not shown), capable of activating the motorized driving means 411 and thus implementing the storage of the folded protection tarpaulin 2 from a folded deployed state to a retracted state in the storage means 3.

According to an alternative embodiment of the invention, the hail protection system 1 comprises processing means (not shown) as well as a transmitter/receiver device (not shown), capable of receiving a signal for activating the motorized driving means 41 from external wireless control means, and thus implementing the storage of the protection tarpaulin 2.

In practice, the first rotating roller 42 is disengaged from the driving means 41 if said driving means 41 is deactivated.

According to an alternative embodiment of the invention, the spring-type driving means 412 incorporates a means for locking the protection tarpaulin 2 in an unfolded state, capable of blocking the spring-type driving means 412 and thus preventing the retraction of said tarpaulin 2.

The deployment procedure for the hail protection tarpaulin 2 is performed by manually opening the hatch 6, whereby the user pulls the distal part 26 of the protection tarpaulin 2 and deploys said tarpaulin 2 lengthwise along the vehicle 100, thus getting the folded protection tarpaulin 2 into a deployed state.

The user will then unfold the side panels 24 to allow the protection tarpaulin to cover the sides of the vehicle 100 and thus obtain an unfolded state.

In practice, the deployed protection tarpaulin 2 covers the entire vehicle 100, unlike existing deployment systems that leave part of the rear bumper unprotected.

The system according to the invention allows a simple installation of the tarpaulin, this one being ready to use, in a rolled up configuration.

According to a particular embodiment of the invention, the roll-up and deployment is performed in ten seconds or less.

It is to be noted that the positioning of the storage means 3 is furthermore configured to limit the modification of the aerodynamics of the vehicle 100.

The storage procedure of the hail protection tarpaulin 2 is carried out by implementing the driving means 41, which is connected to the point of attachment of the proximal part 25 of the tarpaulin 2, the rotation of the first rotating roller 42 and of the second rotating roller 43 thanks to the transmission means 411 drive the guiding storage of the protection tarpaulin 2 according to a configuration of roll-up of the protection tarpaulin 2 on itself, around the two rotating rollers 42, 43, in the shape of a crushed O.

Surprisingly, the system according to the invention allows a simplified installation and fastening, while allowing for simplicity of use for the user.

Advantageously, the viscoelastic properties and low shrinkage rate of the protection tarpaulin 2 allow for the implementation of a particular roll-up configuration by the storage mechanism 4, thus facilitating its storage in the storage means 3 while limiting the deformation of the protection tarpaulin 2, and guaranteeing a high rate of protection of the vehicle 100 against hailstorms.

Another advantage of the arrangement of the storage means 3 under the chassis of the vehicle 100 is that a greater storage length is available, thus allowing storage according to a particular lengthwise winding configuration of the protection tarpaulin, the latter being thus wound lengthwise along the length of the chassis of the vehicle, and limiting the number of revolutions around the two rotating rollers 42, 43, and making it possible to minimize the deformations relating to the storage of said protection tarpaulin. The chassis of the vehicle also being wider than a trunk, it allows the storage means 3 and the tarpaulin 2 to be wider than the conventional protection systems.

As the system uses repeated phases of rolling up and unrolling, such a storage configuration allows moreover for the maintenance of the physical integrity of the protection tarpaulin 3.

What is claimed is:

1. A hail protection tarpaulin for a vehicle comprising:
an outer layer being impermeable and tear-resistant and designed to be in contact with hail;
a non-abrasive inner layer intended to be placed in direct contact with the vehicle to be protected; and
at least one intermediate layer arranged between the outer layer and the inner layer the at least one intermediate layer being which is ductile and having has a low shrinkage rate, and being composed of at least one type of vibroabsorbent and viscoelastic elastomer, the elastomer being arranged in crystalline microcells, and capable of absorbing and dispersing horizontally shocks produced by the impact of the hail on the outer layer, wherein the outer layer, non-abrasive inner layer and the at least one intermediate layer are configured to be rolled up as a multi-layer assembly.

2. The A hail protection tarpaulin according to claim 1, further comprising a central panel adapted to cover the vehicle along its length, and side panels adapted to be folded/unfolded, and to cover the fenders of the vehicle.

3. The A hail protection tarpaulin according to claim 2, further comprising at least two lines of attenuation arranged in the lengthwise direction of said protection tarpaulin ,at least two lines of attenuation to allow the folding of the side flaps towards a the central panel thereof, and to allow the unfolding of the side flaps of the hail protection tarpaulin from the central panel towards the fenders of the vehicle .

4. The hail protection tarpaulin according to claim 2, further comprising fixing means arranged on a distal end (26) of the hail protection tarpaulin ,capable of being fixed to the front part of the vehicle, and of allowing the hail protection tarpaulin to be held in the deployed position.

5. The hail protection tarpaulin according to claim 2, further comprising a fastening means allowing the hail protection tarpaulin to be held in a folded position, and allowing said hail protection tarpaulin to be stored.

6. A hail protection system for vehicle comprising:
hail protection tarpaulin;
a storage mechanism for the hail protection tarpaulin, comprising storage means adapted to be fixed to the rear chassis of a vehicle, at the level of the rear part of the underbody of said vehicle by selected fixing means, and comprising:
two rotating rollers parallel to each other and to the axles of the vehicle (100), arranged at a distance from each other, and capable of rolling up the protection tarpaulin on itself, under tension between the two rollers according to a roll-up configuration whose roll-up center corresponds to the two rotating rollers in order to allow a lengthwise storage of the latter;
a driving loop surrounding the two rotating rollers integrated with the proximal end of the hail protection tarpaulin in order to provide an anchoring point during the storage procedure of said protection tarpaulin;
a driving means arranged on at least one of the rotating rollers, adapted to rotate said rotating roller and thus cause the storage of the hail protection tarpaulin in the storage means, and adapted to allow the transition from a deployed state in which the hail protection tarpaulin at least partially covers the vehicle, to a retracted state of the hail protection tarpaulin in which the hail protection tarpaulin is housed and rolled up in a selected configuration in the storage means;
the upper part of the storage means, in contact with the rear part of the underbody of the vehicle, comprises a thermally insulating surface, capable of protecting the protection tarpaulin from the exhaust system of the vehicle.

7. The A hail protection system according to claim 6, wherein the storage mechanism comprises a disengaged mode in which the rotating rollers are disengaged from driving means allowing manual deployment of the protection tarpaulin.

8. The A hail protection system according to claim 6, further comprising processing means, and transmitter/receiver device, the processing means and the transmitter/receiver device capable of receiving a signal for activating the driving means using external wireless control means.
